(19) United States
(12) Patent Application Publication
(10) Pub. No.: US 2002/0101048 A1
(43) Pub. Date: Aug. 1, 2002

(54) Transfer vehicle

(76) Inventor: Gordon A. Sword, Hemet, CA (US)

Correspondence Address: ROB L. PHILLIPS, LAW OFFICES OF BOYD & PHILLIPS, 30011 IVY GLENN DR., SUITE 108, LAGUNA NIGUEL, CA, 92677, US

(21) Appl. No.: 09/770,747

(22) Filed: Jan. 31, 2001

(51) Int. Cl. B62B 7/00

(52) U.S. Cl. 280/47.38; 280/47.34

(57) ABSTRACT

A transfer vehicle comprising a frame, handlebar, seat and one or more wheels. The transfer vehicle is designed to assist a disabled individual with transfer to and from a wheelchair to a couch, chair, bed, commode or the like. A lower horizontal support section, in the shape of a rectangle, is joined to an upper horizontal support section, in the shape of a rectangle, by means of four vertical support members. Additional support is provided by incorporating two reinforcement members between two cross section members and the upper horizontal support section. The upper horizontal support section overhangs the lower horizontal support section and joins a front horizontal member by means of two short vertical members. Two angled members join the lower horizontal support section to the front horizontal member and a handlebar for support. Two fixed rear wheels and two front wheels attached to a swivel mechanism allow the transfer vehicle to be steered into nearly any location. A seat mounted to the upper horizontal support section provides the disabled user a comfortable experience.

### FIELD OF THE INVENTION

An apparatus is designed to assist a disabled individual, namely, an individual with limited use of his or her legs. The present invention is such that it is used in conjunction with a conventional wheelchair. The transfer vehicle disclosed herein is utilized by the disabled to enable them to transfer to and from a wheelchair to a new seated position on a bed, chair, commode or the like. Transferring from a wheelchair to another seated position is a major challenge associated with conventional wheelchairs which do not always include removable arm rests. The challenge is addressed by the present invention.

### BACKGROUND OF THE INVENTION

Functioning in the fast-paced world we live is no easy task. Imagine the additional hardships faced by those persons incapable of walking. The physically disabled must face the world at a definite physical disadvantage to the majority of the population. Thirty people a day become disabled requiring them to use a wheelchair for the remainder of their lives

Over the years much has been done to improve the life style of the disabled. The government has passed and enforces legislation known as the Americans with Disabilities Act (ADA). The legislation is intended to insure handicapped persons have equal access to public venues. The legislation has been, and continues to be, successful and has resulted in much more public access for the handicapped.

In addition to the legislation, there have been countless apparatuses designed to assist the handicapped. The databases of Patent and Trademark Office (PTO) are loaded with issued patents intended to assist handicapped persons with their everyday lives. Many of the issued patents are directed to wheelchair improvements and the like. Patent No. 4,515,385 discloses a wheelchair invention wherein a handicapped individual can, without assistance, modify the dimensional and mobility characteristics of said wheelchair. Patent No. 5,112,076 discloses a wheelchair with a removable seat. Certainly the wheelchair inventions patented to date are extremely important and assist in mobility but another critical and difficult challenge faced by handicapped individuals is transferring to and from a wheelchair to other seated positions on a bed, couch, commode or the like.

Transferring to and from a wheelchair normally requires the disabled to elicit assistance from a non-handicapped individual. Unfortunately, a non-handicapped individual is not always readily available to assist in the transfer to and from the wheelchair.

The inherent problem with transferring to and from wheelchairs is the fault of the wheelchair back rest and arm rests The conventional wheelchair design restrains the handicapped individual's movement. The only available movement the conventional wheelchair allows is in the forward direction of the wheelchair. One direction of movement does not allow a handicapped individual to safely and efficiently transfer to and from a wheelchair. Where possible, removing the arm rails of the wheelchair only allows a sideway transfer that does not provide the disabled individual a completely safe movement from the wheelchair. The present invention allows the disabled individual three unimpeded directions of movement for easy and safe transfer.

Certainly there is no shortage of good Samaritans attempting to improve the ability of handicapped individuals to transfer to and from their wheelchairs. Evidence in great numbers is contained within the PTO's databases of issued patents. Patent Nos. 5,207,549 and 5,674,041 disclose transfer methods between a wheelchair and an automobile seat. However, the concept is very limited in its use and is only beneficial to transfer from a wheelchair to an automobile. Patent No. 4,888,833 discloses a cart for positioning a body on a toilet. However, the invention is very specific to toilets and does not claim to transfer the user to the toilet surface but rather places the user over the toilet. Again, the aforementioned are definitely bright inventions but they do not afford the user the flexibility of the present invention.

Patent No. 5,884,929 discloses a novel invalid transport capable of transferring a handicapped individual to and from the transport. The design set forth in 5,884,929 resembles a conventional wheelchair but is designed such that a rotatable seat is capable of moving fore-and-aft allowing the seat to be positioned outside the constraints of the wheelchair frame. Unfortunately, the design is complex and costly to the handicapped user. Patent No. 6,036,216 discloses a simple method of transferring a handicapped individual by means of removable wheelchair arms and a transfer board to create a link between the wheelchair and the new seated position. The transfer board method disclosed in 6,036,216 is simply too unreliable and dangerous for handicapped users.

The present invention is placed sideways between the disabled individual's knees whereby the individual places one leg over the seat and mounts the transfer vehicle like a pony. A disabled individual may require use of his arms to lift his leg over the seat. To complete the transfer the user backs the transfer vehicle against a desired item (i.e. chair) and simply slides back onto the item. The transfer vehicle is propelled by the user's feet and body momentum. The user holds a handlebar for balance and support during his or her use of the transfer vehicle.

### SUMMARY OF THE INVENTION

The present invention addresses the problems not resolved by the prior art. An object of the present invention is to provide a transfer vehicle capable of unaided use by the disabled

Another object of the present invention is to provide a transfer vehicle capable of safe and easy unaided transfer to and from a wheelchair.

A further object of the present invention is to provide a transfer vehicle capable of easy manufacture to keep the cost as low as possible for the disabled end-user.

Yet another object of the present invention is to provide the disabled user a taste of independence while simultaneously providing a care giver extra time to conduct other activities.

Still another object of the present invention is to provide a transfer vehicle capable of transferring a handicapped individual between a wheelchair and a variety of seated positions and vice versa.

### BRIEF DESCRIPTION OF THE DRAWINGS

FIG. 1 is a perspective side view of the preferred embodiment of the transfer vehicle;

FIG. 2 is a front view of the preferred embodiment of the transfer vehicle;

FIG. 3 is a rear view of the preferred embodiment of the transfer vehicle,

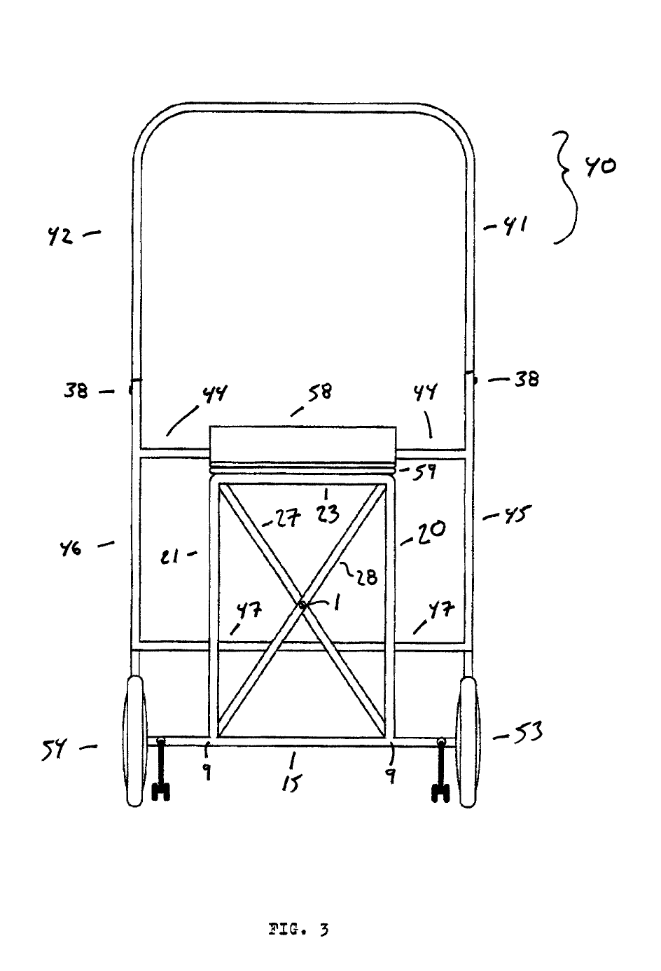

FIG. 4 is a side view of a second embodiment of the transfer vehicle;

FIG. 5 is a rear view of a second embodiment of the transfer vehicle;

FIG. 6 is a top view of a second embodiment of the transfer vehicle.

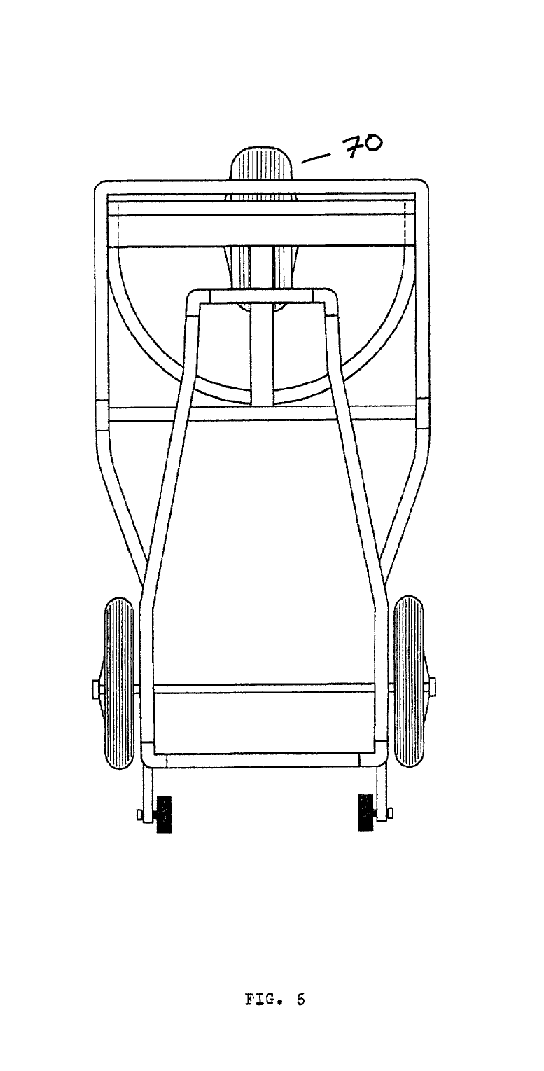

### DETAILED DESCRIPTION OF THE PREFERRED EMBODIMENTS

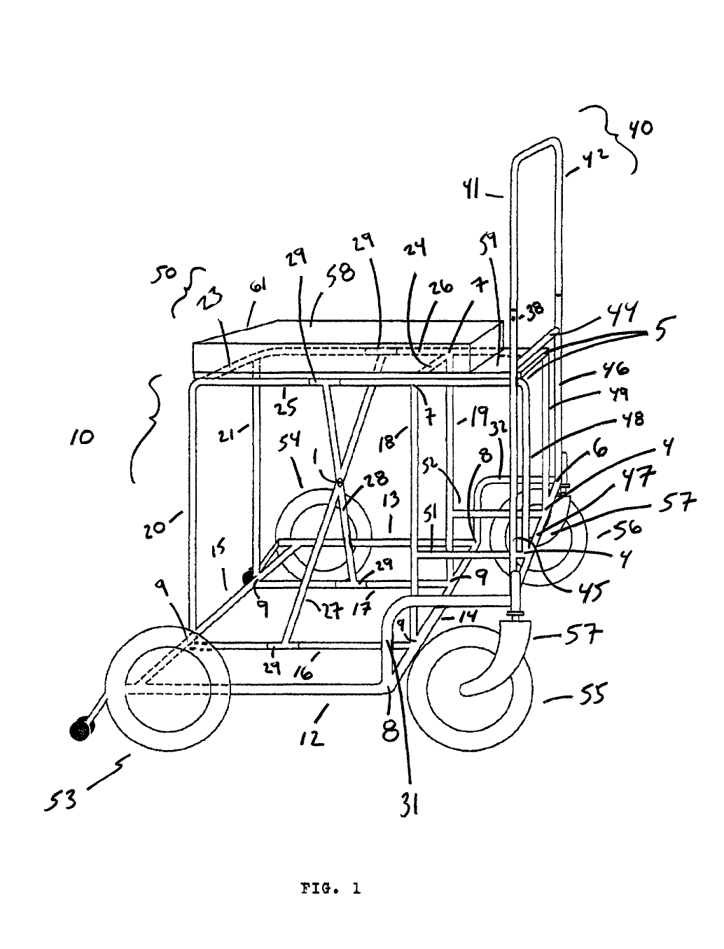

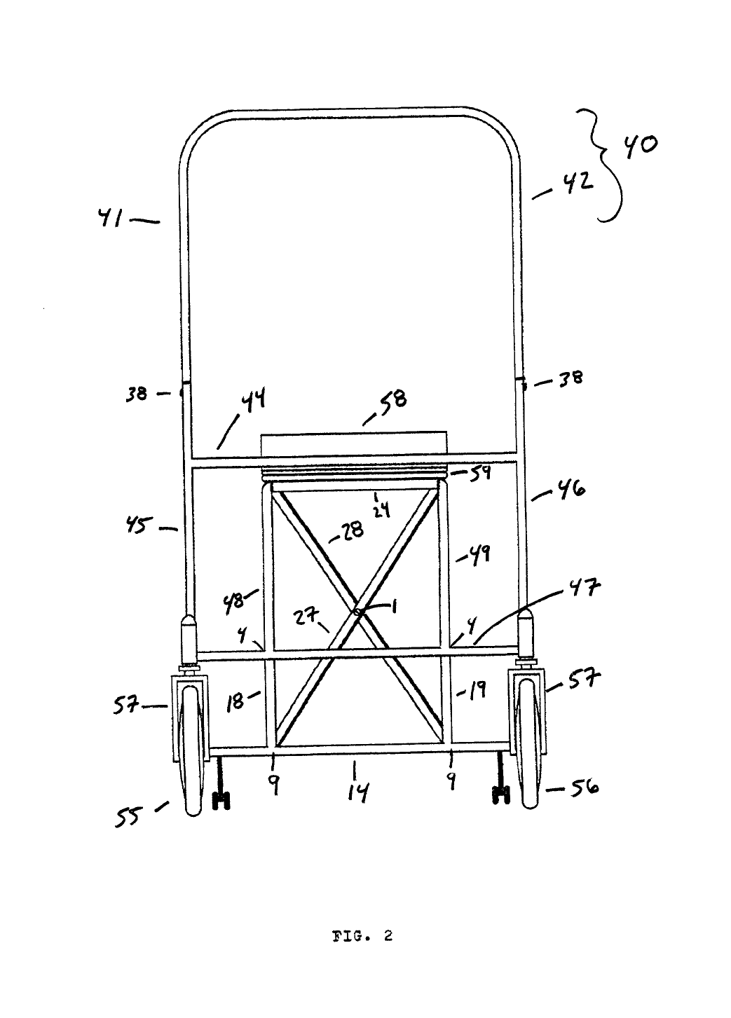

Referring to FIGS. 1, 2, & 3, the preferred embodiment of the transfer vehicle comprises a frame 10, including a handlebar 40, a seat 50, two rear wheels 53, 54 and two front wheels 55, 56. In several respects, the transfer vehicle disclosed herein is similar in design to a conventional wheelchair in that it is operated by a handicapped individual and relies on wheels for portability. However, the design is unique in that the frame 10 allows the handicapped individual to safely move to and from the transfer vehicle with little effort. Those skilled in the art understand that there are numerous frame designs capable of providing structure and support without departing from the scope of the invention as described

The frame 10 of the transfer vehicle comprises a lower horizontal support section with a first short lower member 12, a second short lower member 13, a first long lower member 14 and a second long lower member 15 all joined to form a rectangle. The first short lower member 12 and the second short lower member 13 of the lower horizontal support section extend from a front section of the transfer vehicle to a rear section of the transfer vehicle. A first cross-section member 16 and a second cross-section member 17 extend parallel to the first short lower member 12 and second short lower member 13 and are joined to the first long lower member 14 and the second long lower member 15. The first cross-section member 16 and the second cross-section member 17 tri-sect the lower horizontal support section.

Four long vertical support members 18, 19, 20, 21 are joined to the lower horizontal support section at joints 9 formed by the horizontal lower support section and the first cross-section member 16 and the second cross-section member 17 such that two long vertical support members 18, 19 extend from the first long lower member 14 and two long vertical support members 20, 21 extend from the second long lower member 15 and are joined to an upper horizontal support section. The upper horizontal support section comprises a first short upper member 23, a second short upper member 24, a first long upper member 25 and a second long upper member 26 all join to form a rectangle. The first long upper member 25 and the second long upper member 26 of the upper horizontal support section extend from the rear section of the transfer vehicle, beyond joints 7 formed by the first long upper member 25 and the long vertical support member 18 and the second long upper member 26 and the long vertical support member 19, to the front section of the transfer vehicle such that they extend beyond, and overhang, the first long member 14 of the lower horizontal support section.

A first reinforcement member 27 and a second reinforcement member 28 are attached to the lower horizontal support section and the upper horizontal support section. Said first reinforcement member 27 extends vertically from the first cross-section member 16 and attaches to the second long upper member 26 of the upper horizontal support section and said second reinforcement member 28 extends vertically from the second cross-section member 17 and attaches to the first long upper member 25 of the horizontal support section. The first reinforcement member 27 and the second reinforcement member 28 are secured to each other at their intersection point 1 forming an “X” design for support within the frame 10. The first reinforcement member 27 and the second reinforcement member 28 are attached to the first cross-section member 16, the second cross-section member 17 and the upper horizontal support member by means of sleeves 29 fitted to the ends of the first reinforcement member 27 and the second reinforcement member 28. The sleeves 29 fit securely around the first cross-section member 16, the second cross-section member 17 and the first long upper member 25 and second long upper member 26 of the upper horizontal support section.

A first angled member 31 and a second angled member 32 extend vertically upward a short distance from joints 8 formed by the first long lower member 14 and the first short lower member 12 and the second short lower member 13 and incrementally bend 90° such that they extend parallel to the lower horizontal support section in the direction of the front section of the transfer vehicle. A front horizontal member 47 extends from the first angled member 31 and joins the second angled member 32 at joints 6 formed by a first vertical member 45, a second vertical member 46 and the first angled member 31 and the second angled member 32.

A handlebar 40 with an inverted U-shape has a first leg 41 and a second leg 42 which insert into the first vertical member 45 and the second vertical member 46 that extend upward from the first angled member 31 and the second angled member 32. The handlebar 40 includes a handlebar support member 44 which extends horizontally between the first leg 41 and the second leg 42. The handlebar 40 is designed to support the user during the transfer procedure. In the preferred embodiment the handlebar 40 can be removed for the user's convenience. The means for securing the handlebar 40 is a spring loaded push button 38 which first protrudes through an opening in the first leg 41 and then protrudes through an opening in the first vertical member 45 securing the handlebar in place. The user can simply push the spring loaded push button 38 causing a spring to compress and the button to recede releasing the handlebar 40 which can then be freely lifted out of its insertion in the first vertical member 41 and the second vertical member 42.

Two short vertical support members 48, 49 extend vertically from the front horizontal member 47 and join the upper horizontal support section at joints 5 formed by the first long upper member 25, the second long upper member 26 and the second short upper member 24. Two short horizontal members 51, 52 are joined to vertical support members 18, 19 and extend forward to join the front horizontal member 47. The two short horizontal members 51, 52 join the front horizontal member at joints 4 formed by the front horizontal member 47 and the two short vertical members 48, 49.

Two rear wheels 53, 54 are attached to the first short lower member 12 and the second short lower member 13. The fixed rear wheels 53, 54 have only one plane of motion in the forward and rear direction. Two front wheels 55, 56 are each attached to a swivel mechanism 57 allowing them to rotate a full 360° for transfer vehicle portability and mobility. The swivel mechanisms 57 are permanently attached to the first vertical member 45 and the second vertical member 46. The front wheels 55, 56 are used to steer the transfer vehicle. The front wheels 55, 56 are similar, if not identical, to the front wheels on a conventional wheelchair

A cushion 58 is attached to a cushion mounting support 59 forming a seat 50 which is attached to an upper surface of the upper horizontal support section. One end 61 of the cushion rests flush upon the first short member 23 of the upper horizontal support section providing assured comfort for the disabled user during transfer to and from a wheelchair.

In another embodiment (not shown) of the present invention the reinforcement members 27, 28 are removed and a means for adjusting the height of the four vertical support members 18, 19, 20, 21 is included. The means for adjusting the height of the transfer vehicle is identical to the means for removing the handlebar 40. However, numerous means of adjustability are available. The inventor herein has discovered through actual use that the optimum height of the transfer vehicle is between 17 inches and 23 inches based on the user's size and the height of beds, couches, chairs, commodes and the like.

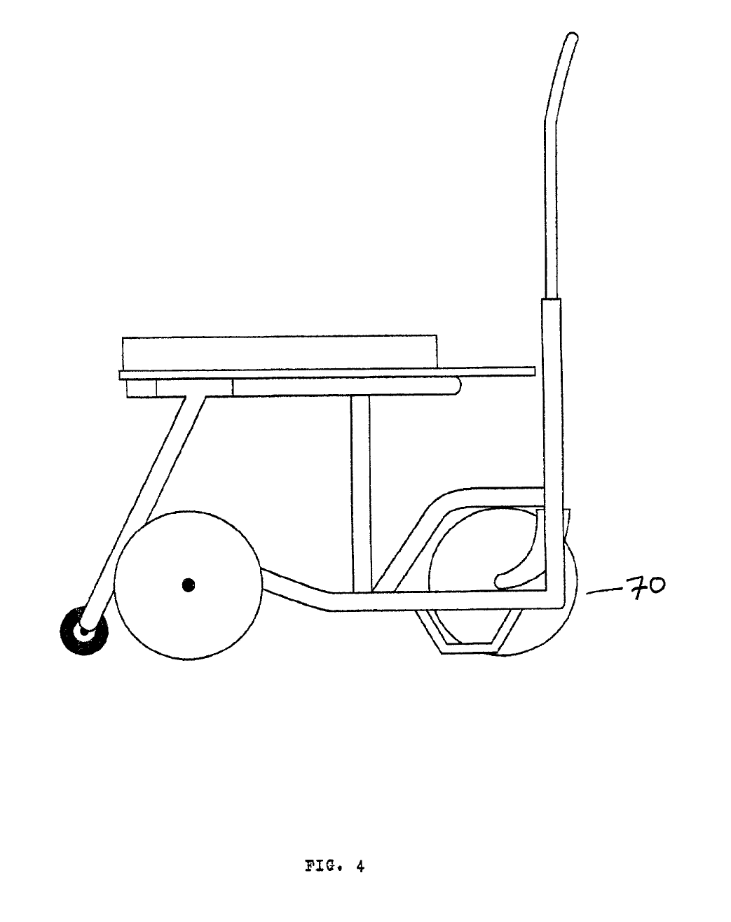

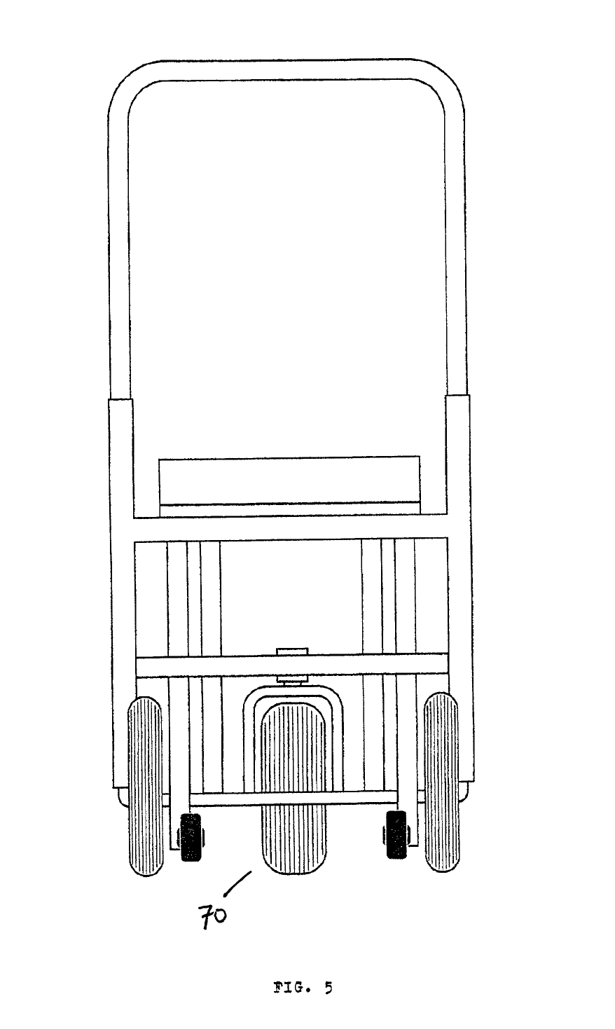

Referring to FIGS. 4, 5 & 6 a second embodiment of the invention is illustrated. The second embodiment includes a second frame design for use with one front wheel 70 rather than two as seen in the preferred embodiment. As with the preferred embodiment the front wheel 70 can rotate a full 360° by means of a swivel mechanism.

In all embodiments the members of the frame are joined by welds but those skilled in the art understand that numerous alternative means to join the members are available.

I claim:

1. A transfer vehicle comprising:
a frame including a lower horizontal support section with a first short lower member, a second short lower member, a first long lower member and a second long lower member all joined to form a rectangle, a first cross-section member and a second cross-section member extend parallel to the first short lower member and second short lower member and are joined to the first long lower member and the second long lower member;
four long vertical support members are joined to the lower horizontal support section at joints of the horizontal lower support section and the first cross-section member and the second cross-section member such that two long vertical support members extend from the first long member and two long vertical support members extend from the second long member and are joined to an upper horizontal support section;
the upper horizontal support section comprises a first short upper member, a second short upper member, a first long upper member and a second long upper member all joined to form a rectangle, the first long upper member and the second long upper member of the upper horizontal support section extend from a rear section of the transfer vehicle, beyond joints formed between the first long upper member and the long vertical support member and the second long upper member and the long vertical support member, to a front section of the transfer vehicle such that they extend beyond, and overhang, the first long member of the lower horizontal support section;
a first angled member and a second angled member extend vertically upward a short distance from joints formed by the first long lower member and the first short lower member and the second short lower member and incrementally bend 90° such that they extend parallel to the lower horizontal support section in the direction of the front section of the transfer vehicle, a front horizontal member extends from the first angled member and joins the second angled member at joints formed with a first vertical member and a second vertical member;
two short vertical support members extend from the front horizontal member and join the upper horizontal support section at joints formed by the first long upper member, the second long upper member and the second short upper member, two short horizontal members are joined to vertical support members and extend forward to join the front horizontal member, the two short horizontal members join the front horizontal member at joints of the front horizontal member and the two short vertical members;
one or more wheels;
and a seat.

2. The transfer vehicle as defined in claim 1 wherein the frame further includes a first reinforcement member and a second reinforcement member attached to the lower horizontal support section and the upper horizontal support section, said first reinforcement member extends vertically from the first cross-section member and attaches to the second long upper member of the upper horizontal support section and said second reinforcement member extends vertically from the second cross-section member and attaches to the first long upper member of the horizontal support section, the first reinforcement member and the second reinforcement member are secured to each other at their intersection point.

3. The transfer vehicle as defined in claim 1 further comprising a handlebar with an inverted U-shape having a first leg and a second leg which insert into a first vertical member and a second vertical member that extend upward from the first angled member and the second angled member;
and a means for removing said handlebar.

4. The transfer vehicle as defined in claim 1 wherein the transfer vehicle comprises two fixed rear wheels and two front wheels attached to a swivel mechanism allowing them to rotate 360° for transfer vehicle portability and mobility, said swivel mechanisms are permanently attached to the first vertical member and the second vertical member.

5. The transfer vehicle as defined in claim 1 wherein the seat is comprised of a cushion attached to a cushion mounting support forming a seat which is attached to an upper surface of the upper horizontal support section with one end of the cushion resting flush upon the first short member of the upper horizontal support section.

6. The transfer vehicle as defined in claim 2 wherein the first reinforcement member and the second reinforcement member are attached to the first cross-section member, the second cross-section member and the upper horizontal support member by means of sleeves fitted to the ends of the first reinforcement member and the second reinforcement member, the sleeves fit securely around the first cross-section member, the second cross-section member and the first long upper member and second long upper member of the upper horizontal support section.

7. The transfer vehicle as defined in claim 3 wherein the means for removing said handlebar is a spring loaded push button, which first protrudes through an opening in the first leg and then protrudes through an opening in the first vertical member and is held in place by the tension in the spring, that holds the handlebar in place.

8. The transfer vehicle as defined in claim 3 wherein the handlebar includes a handlebar support member which extends horizontally between the first leg and the second leg of the handlebar.

9. A transfer vehicle comprising:
a frame;
two rear wheels attached to the frame;
one front wheel attached to the frame;
an adjustable handlebar; and
a seat

10. The transfer vehicle as defined in claim 9 wherein the front wheel is rotatable 360°.
